(19) United States
(12) Patent Application Publication
(10) Pub. No.: US 2024/0116725 A1
(43) Pub. Date: Apr. 11, 2024

(54) Tray Insertion Velocity Limiting Mechanism

(71) Applicant: Lexmark International, Inc., Lexington, KY (US)

(72) Inventors: Patrick Lawrence Ransom, Lexington, KY (US); Brandon Christopher Reynolds, Nicholasville, KY (US)

(21) Appl. No.: 17/962,117

(22) Filed: Oct. 7, 2022

(51) Int. Cl. B65H 1/26

(52) U.S. Cl. CPC B65H 1/266; B65H 2405/31

(57) ABSTRACT

When a media tray is inserted into a printer with the leading edge of the printed page going into the printer first, multiple sheets of media may slide off the media stack (“shingle”) into the paper path if the primary input tray is inserted too aggressively. This may result in double feeds and/or paper jams for the user. Disclosed is a mechanism that is transparent to the user for slow speed tray insertions but provides force feedback to the user indicating tray insertion at too high of speed. If the user inserts the tray below the speed threshold, then the result is a normal tray insertion. If the user inserts the paper tray above the speed threshold, then there is a feedback to the user to slow the tray insertion to an acceptable velocity.

### CROSS REFERENCES TO RELATED APPLICATIONS

None.

### BACKGROUND

### 1. Field of the Invention

This invention relates generally to an insertion velocity limiting mechanism for a printer paper tray.

### 2. Description of the Related Art

Printer tray insertion speed may be a problem when the tray is inserted in a direction such that the leading edge of the printed page is entering the printer first because multiple sheets of media may slide off the media stack into the paper path if the primary input tray is inserted too aggressively.

### SUMMARY OF THE INVENTION

In one printer architecture, the media is loaded into the tray and the tray is inserted with the leading edge of the printed page entering the printer first. In doing so, the page may be picked, imaged, and output toward the user. This configuration makes job retrieval easier for the end user and allows a smaller more compact footprint and overall device. The tradeoff is that multiple sheets of media may slide off the media stack (“shingle”) into the paper path if the primary input tray is inserted too aggressively. This may result in double feeds and/or paper jams for the user.

The invention is a mechanism that is not engaged by the user for slow speed tray insertions but is engaged when the user inserts the tray at too high of speed providing force feedback. Essentially, if the user inserts the tray below the speed threshold, then the result is a normal tray insertion. If the user inserts the paper tray above the speed threshold, then there is a feedback to the user to slow the tray insertion to an acceptable velocity.

A printer device with friction separator pick technology that allows for an orthogonal paper stack does not have this shingling problem. However, an auto-compensating pick technology that requires a slightly shingled paper stack and an inclined pick dam results in the issue addressed by the invention.

This invention is applicable to paper tray insertion, but a similar mechanism could be used for any user action; jam access door closing, scanner lift and lower, imaging unit basket installation, etc.

### BRIEF DESCRIPTION OF THE DRAWINGS

Having thus described the invention in general terms, reference will now be made to the accompanying drawings, which are not necessarily drawn to scale, and wherein:

FIG. 1 shows a prior art media tray.

FIG. 2 shows a media tray of the present invention that is inserted with the leading edge of the media going into the printer first.

FIG. 3 shows how the paper momentum can “shingle” one or more sheets of media slide off the media stack.

FIG. 4 shows a follower design that is mounted to a printer wall.

FIG. 5 shows the follower wheel riding on top of the separator guide along the aggressive tray insertion path.

FIG. 6 shows the follower wheel at the end of the aggressive tray insertion path where the follower wheel impacts the stop element

FIG. 7A shows a hard stop embodiment

FIG. 7B shows a speed bumps embodiment.

FIG. 7C shows a friction pad embodiment.

FIG. 7D shows a soft close embodiment.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. As used herein, the terms “having,” “containing,” “including,” “comprising,” and the like are open ended terms that indicate the presence of stated elements or features, but do not preclude additional elements or features. The articles “a,” “an,” and “the” are intended to include the plural as well as the singular, unless the context clearly indicates otherwise. The use of “including,” “comprising,” or “having” and variations thereof herein is meant to encompass the items listed thereafter and equivalents thereof as well as additional items. Terms such as “about” and the like are used to describe various characteristics of an object, and such terms have their ordinary and customary meaning to persons of ordinary skill in the pertinent art.

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

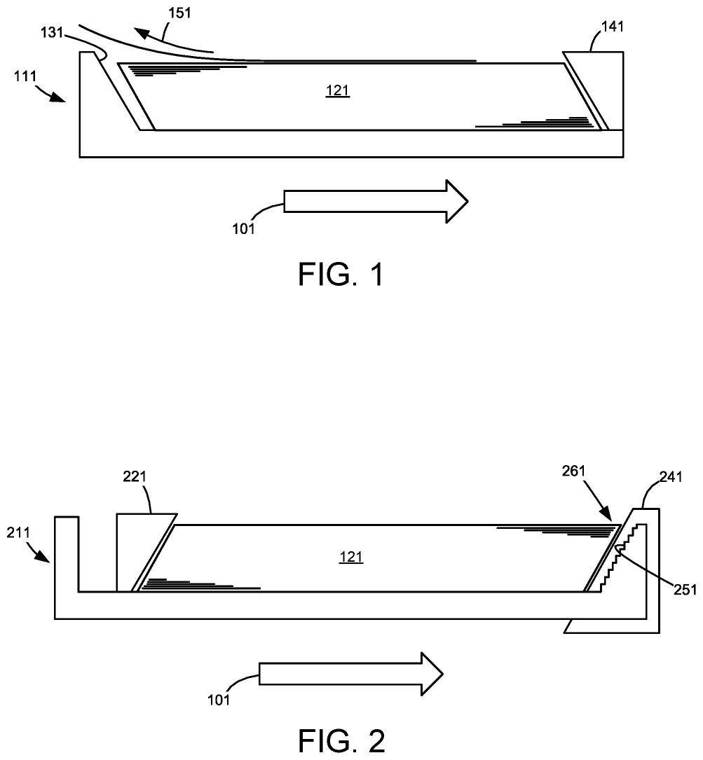

Referring initially to FIG. 1, a prior art media tray is shown. The tray 111 is inserted in the direction 101. The media 121 is taken from the inclined pick surface 131 in the direction 151 shown.

FIG. 2 shows a media tray of the present invention that is inserted with the leading edge 261 of the media going into the printer first. The tray is inserted in the direction 101, meeting an inclined pick surface 241 on the printer (not shown). Paper stops 251 on the media tray 211 position the media 121.

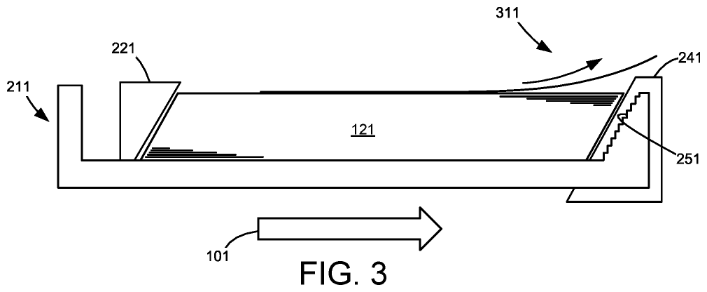

FIG. 3 shows how the paper momentum can “shingle” 311 one or more sheets of media slide off the media stack 121 up the pick surface 241 and into the paper path (not shown) when the tray is inserted too aggressively, i.e., at too great a speed. This can cause excessive skew of the paper and/or paper jams.

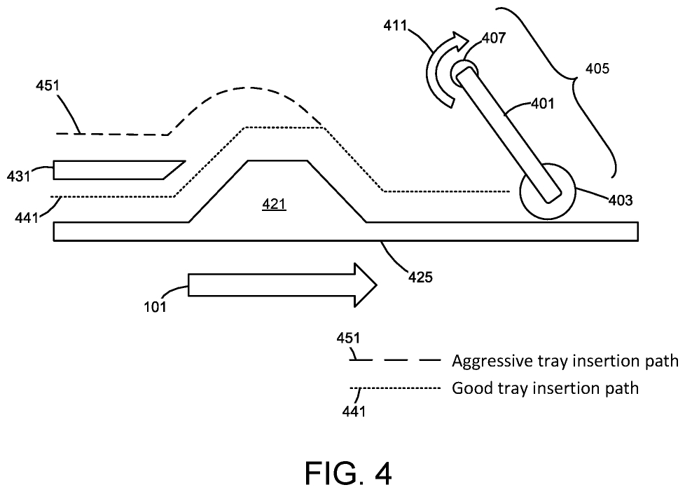

FIG. 4 shows a “follower” 405 design that is mounted to the printer wall (not shown). The follower 405 has an arm 401, a roller 403, and pivot connection 407 to the printer wall (not shown). The follower is biased 411 to remain in contact with the tray body when the tray is inserted. When a tray is inserted at a low velocity, the follower wheel 403 will ride up and over a cam surface 421 on the tray body 425 and follow the preferred “good tray insertion path” 441. If, however, the tray is inserted with too much velocity, the follower wheel 403 will follow the “aggressive tray insertion path” 451 after riding over the cam surface 421. Effectively, with too much insertion velocity, the follower wheel 403 will “jump” to the higher path and ride along a separator guide 431.

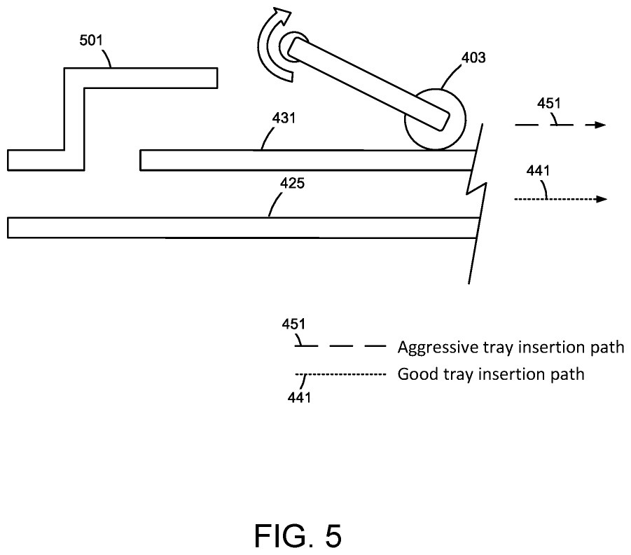

FIG. 5 shows the follower wheel 403 riding on top of the separator guide 431 along the aggressive tray insertion path 451. As the tray insertion continues, the roller is approaching as stop element 501.

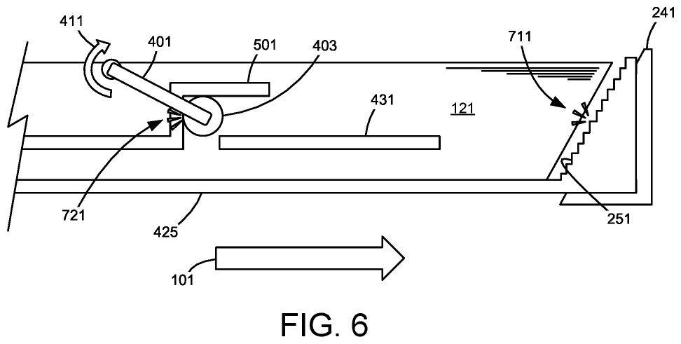

FIG. 6 shows the follower wheel 403 at the end of the aggressive tray insertion path 451 where the follower wheel 403 impacts 721 the stop element 501. For reference, the media stack 121 is shown. The impact 721 of the follower wheel 403 arrests the movement of the media stack 121 in the tray insertion direction 101, limiting the impact 711 of the media stack 121 with the pick surface 241, and thus limiting the shingling 311 of the paper where one or more sheets of media slide off the media stack 121 up the pick surface 241 and into the paper path (not shown) when the tray is inserted too aggressively.

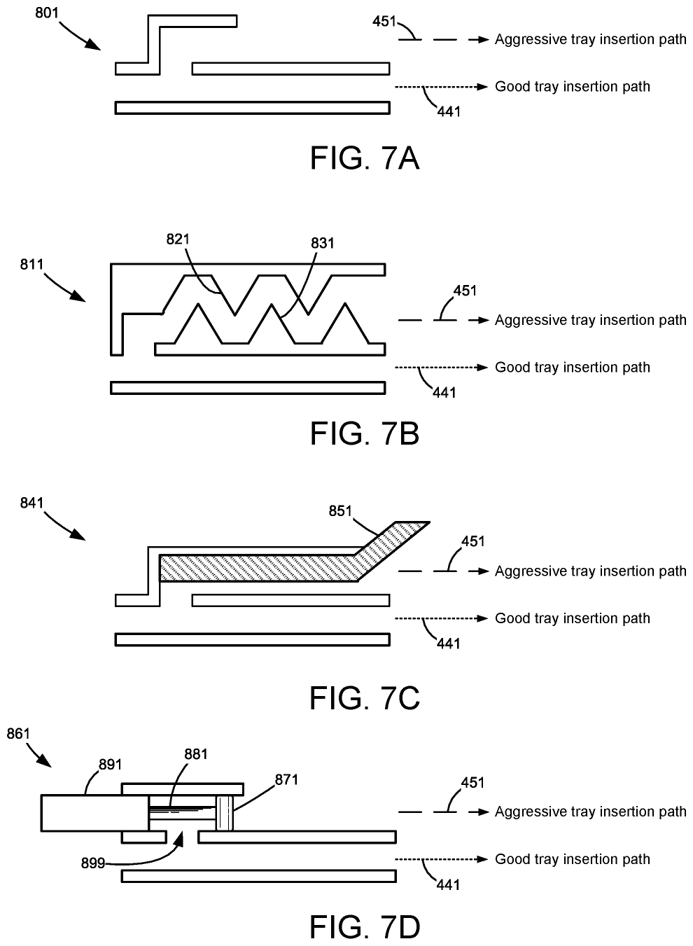

FIGS. 7A, 7B, 7C, and 7D show alternate embodiments of the limiting mechanism to prevent aggressive tray insertion FIG. 7A shows the hard stop 801 embodiment described above. FIG. 7B shows “speed bumps” 821 and 831 that restrict the progress of the follower wheel 403. FIG. 7C shows a friction pad 851 element that inhibits the progress of the follower wheel 403 along the aggressive tray insertion path 451.

Finally, FIG. 7D shows a soft close design 861 with a pusher contact 871, a rod 881, and a damper 891 that may or may not have an internal spring element. The follower wheel 403 meets the pusher contact and must displace the pusher contact 871 to force the rod 881 into the damper to open the path 899 for the follower wheel 403 to pass.

The foregoing description of several embodiments of the invention has been presented for purposes of illustration. It is not intended to be exhaustive or to limit the invention to the precise forms disclosed, and obviously many modifications and variations are possible in light of the above teaching. It is intended that the scope of the invention be defined by the claims appended hereto.

We claim:

1. A media tray insertion velocity limiting device, comprising:
a follower element mounted to a printer wall with a pivot connection, an arm, a roller, and a biasing element;
a cam surface on a media tray body; and
a stop element;
wherein when the media tray is inserted with a velocity sufficient to allow one or more sheets of a media to slide off a media stack up a pick surface and into a paper path, the follower wheel will follow a path that will encounter the stop element.

2. A media tray insertion velocity limiting device, comprising:
a follower element mounted to a printer wall with a pivot connection, an arm, a roller, and a biasing element;
a cam surface on a media tray body; and
an element sufficient for arresting progress of the follower element when the media tray is inserted with a velocity sufficient to allow one or more sheets of a media to slide off a media stack up a pick surface and into a paper path, the follower wheel will follow a path that will encounter the stop element.

3. The media tray insertion velocity limiting device of claim 2, wherein the element sufficient to arrest the progress of the follower element is a speed bump configuration.

4. The media tray insertion velocity limiting device of claim 2, wherein the element sufficient to arrest the progress of the follower element is a friction pad.

5. The media tray insertion velocity limiting device of claim 2, wherein the element sufficient to arrest the progress of the follower element is a damper.
